(19) United States
(12) Patent Application Publication
(10) Pub. No.: US 2018/0063742 A1
(43) Pub. Date: Mar. 1, 2018

(54) ACCESS POINT POWER SAVE WITH DUTY CYCLING

(71) Applicant: QUALCOMM Incorporated, San Diego, CA (US)

(72) Inventors: Zhanfeng JIA, Belmont, CA (US); Ning ZHANG, Saratoga, CA (US); Simon BRAND, Pleasanton, CA (US)

(21) Appl. No.: 15/247,335

(22) Filed: Aug. 25, 2016

(51) Int. Cl. H04W 28/02; H04L 12/26; H04W 4/02

(52) U.S. Cl. CPC H04W 28/0231; H04L 43/0882; H04W 88/08; H04W 4/023; H04L 43/16

(57) ABSTRACT

Systems and methods for wireless communications are disclosed, such as an apparatus for wireless communications. The apparatus generally includes an interface for communicating with a plurality of wireless nodes via a plurality of antennas, a memory; and a processor coupled with the memory and configured to determine one or more indications for a set of network load factors for a wireless network of a plurality of wireless nodes and changing, based on the determined one or more indications for a set of network load factors, from a first set of radios used for communicating with at least one of the wireless nodes to a second set of radios used for communicating with at least one of the wireless nodes.

### BACKGROUND

### Field of the Disclosure

Certain aspects of the present disclosure generally relate to wireless communications and, more specifically, to access point (AP) power save with duty cycling.

### Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks and wireless local area networks (WLANs) based on the Institute of Electrical and Electronics Engineers' (IEEE) 802.11 standards (Wi-Fi).

In wireless communication networks, a wireless access point (AP, e.g., base station) may be capable of accessing the Internet over a wide-area network (WAN) connection and accepting connections over a wireless local area network (WLAN) connection. The AP is capable of connecting to the Internet over the WAN and sharing the Internet connection with wireless devices over the WLAN. As more radios and bands are added to provide higher data rates and larger coverage ranges for wireless devices, AP power consumption increases and significant amounts of power may be needed to provide these connections. Reducing the amount of power required by the AP while minimizing the operations impact is thus desirable.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Aspects of the present disclosure provide a method for wireless communications by a base station. The method generally includes determining one or more indications for a set of network load factors for a wireless network of a plurality of wireless nodes and changing, based on the determined one or more indications for a set of network load factors, from a first set of radios used for communicating with at least one of the wireless nodes to a second set of radios used for communicating with at least one of the wireless nodes.

Aspects of the present disclosure provide an apparatus for wireless communications by a base station. The base station generally an interface for communicating with a plurality of wireless nodes via a plurality of antennas, and a processing system configured to determine one or more indications for a set of network load factors for a wireless network of a plurality of wireless nodes and change, based on the determined one or more indications for a set of network load factors, from a first set of radios used for communicating with at least one of the wireless nodes to a second set of radios used for communicating with at least one of the wireless nodes.

Aspects of the present disclosure provide an apparatus for wireless communications by a base station. The base station generally includes means for determining one or more indications for a set of network load factors for a wireless network of a plurality of wireless nodes, and means for changing, based on the determined one or more indications for a set of network load factors, from a first set of radios used for communicating with at least one of the wireless nodes to a second set of radios used for communicating with at least one of the wireless nodes.

Aspects of the present disclosure provide computer readable medium having instructions stored thereon. The computer readable medium generally includes instructions for one or more indications for a set of network load factors for a wireless network of a plurality of wireless nodes, and changing, based on the determined one or more indications for a set of network load factors, from a first set of radios used for communicating with at least one of the wireless nodes to a second set of radios used for communicating with at least one of the wireless nodes.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates a diagram of an example wireless communications network, in accordance with certain aspects of the present disclosure.

FIG. 2 illustrates a block diagram of an example access point and user terminals, in accordance with certain aspects of the present disclosure.

FIG. 3 illustrates a flow diagram of example operations wireless communications by a base station, in accordance with certain aspects of the present disclosure.

FIG. 4 illustrates a diagram of example duty cycles, in accordance with certain aspects of the present disclosure.

FIG. 5 illustrates a diagram of an example design for a multi-radio chain wireless device, in accordance with certain aspects of the present disclosure.

FIGS. 6A and 6B illustrate diagrams of example operations of a wireless device, in accordance with certain aspects of the present disclosure.

### DETAILED DESCRIPTION

Aspects of the present disclosure provide for wireless communications by a base station. For example, the apparatus may include an interface for communicating with a plurality of wireless nodes via a plurality of antennas and a processing system configured to determine a wireless network traffic characteristic for a plurality of associated wireless nodes, and change from a first set of radios used for communicating with the wireless nodes to a second set of radios used for communicating with the wireless nodes, based on the determined wireless network traffic characteristic. By dynamically entering a low power state based on determined wireless network traffic characteristics for a plurality of associated wireless nodes, power consumption of an access point may be reduced.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may use sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system uses orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may use interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium.

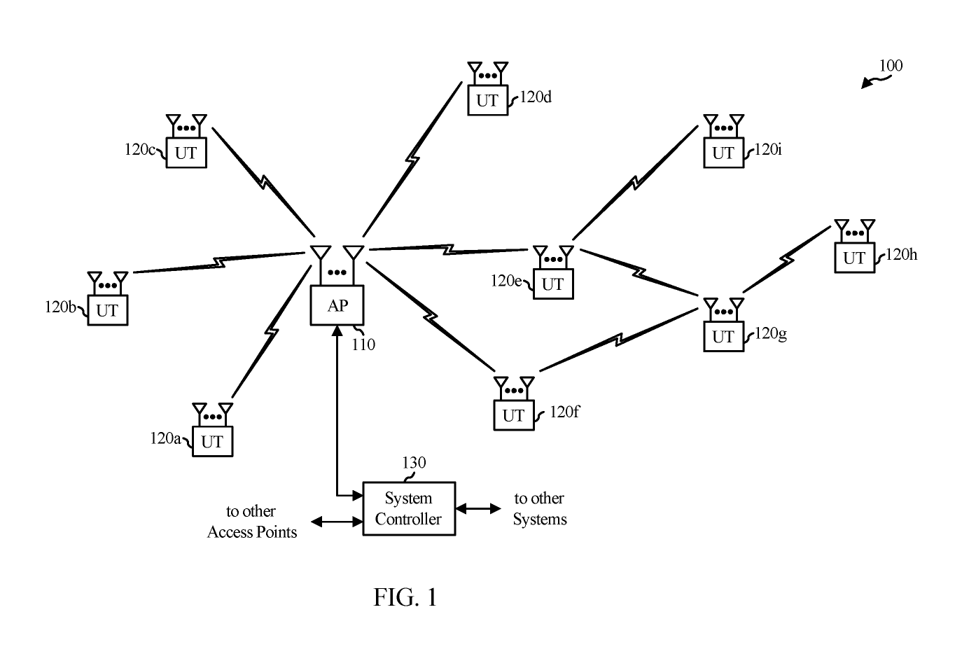

FIG. 1 illustrates a system 100 in which aspects of the disclosure may be performed. For example, the access point 110 or user terminal 120 may determine whether another access point 110 or user terminal 120 is capable of receiving a paging frame (e.g., an ultra low-power paging frame) via a second radio (e.g., a companion radio), while a first radio (e.g., a primary radio) is in a low-power state. The access point 110 or user terminal 120 may generate and transmit the paging frame comprising a command field (e.g., a message ID field) that indicates one or more actions for the other access point 110 or user terminal 120 to take.

The system 100 may be, for example, a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 may couple to and provide coordination and control for the access point.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The access point 110 and user terminals 120 employ multiple transmit and multiple receive antennas for data transmission on the downlink and uplink. For downlink MIMO transmissions, Nₐₚ antennas of the access point 110 represent the multiple-input (MI) portion of MIMO, while a set of K user terminals represent the multiple-output (MO) portion of MIMO. Conversely, for uplink MIMO transmissions, the set of K user terminals represent the MI portion, while the Nₐₚ antennas of the access point 110 represent the MO portion. For pure SDMA, it is desired to have Nₐₚ≧K≧≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also use a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

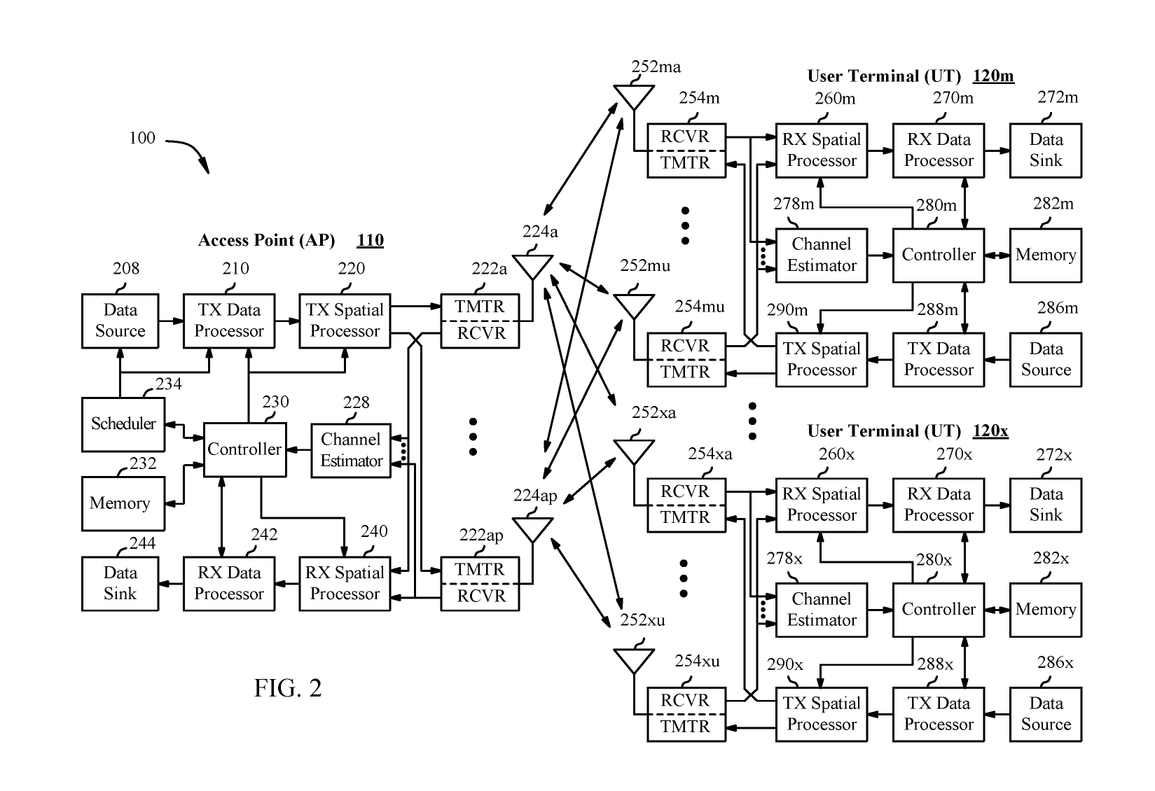

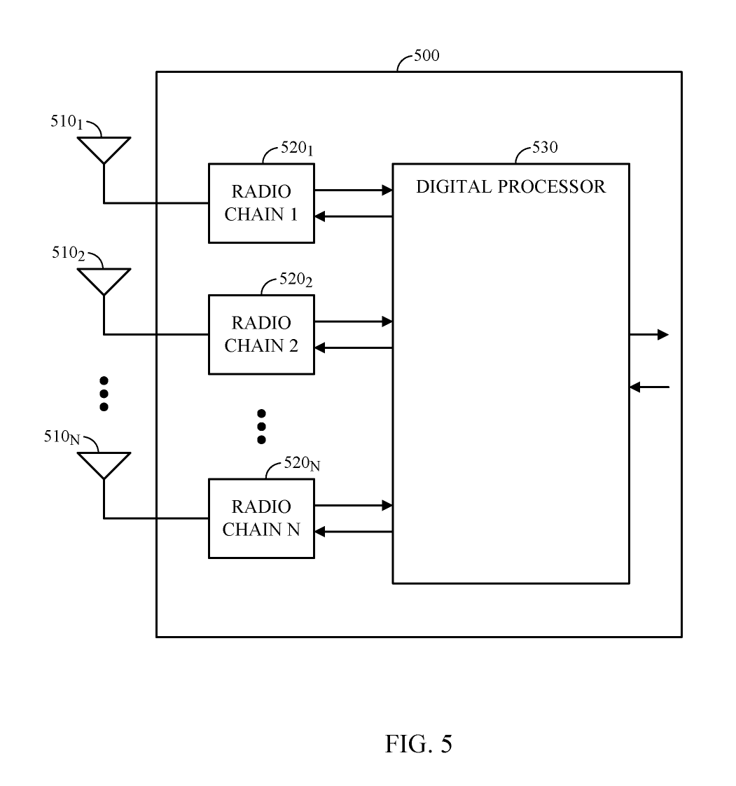

FIG. 2 illustrates example components of the AP 110 and UT 120 illustrated in FIG. 1, which may be used to implement aspects of the present disclosure. One or more components of the AP 110 and UT 120 may be used to practice aspects of the present disclosure. For example, antenna 224, Tx/Rx 222, processors 210, 220, 240, 242, and/or controller 230 may be used to perform the operations described herein and illustrated with reference to FIGS. 5-5A.

FIG. 2 illustrates a block diagram of access point 110 and two user terminals 120m and 120x in MIMO system 100. The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink. For SDMA transmissions, Nᵤₚ user terminals simultaneously transmit on the uplink, while N_{dn} user terminals are simultaneously transmit on the downlink by the access point 110. Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 208 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nup user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal. The decoded data for each user terminal may be provided to a data sink 272 for storage and/or a controller 280 for further processing

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix Hdn,m for that user terminal. Controller 230 derives the spatial filter matrix for the access point based on the effective uplink channel response matrix Hup,eff. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

Each wireless node may include one or more radio chains referring to the components necessary for transmit/receive signal processing. A wireless node implementing a traditional SISO system may include a single radio chain for transmit and receive operations for a particular set of frequencies (e.g., 2.4 GHz). A second radio chain may be included, for example, where the wireless node supports parallel operations in a second set of frequencies (e.g., 5 GHz). Multiple radio chains may also be included where multiple antennas and corresponding components (e.g., radios) are included, such as in MIMO systems. Radio chains may support a variety of frequencies, such as 2.4 GHz, 5 GHz, 900 MHz, 60 GHz, or any other set of frequencies. For example, a tri-band MIMO system may support two 5 GHz bands and one 2.4 GHz band with four antennas for each band. Such a system may support 12 radio chain operations, with 8 chains for 5 GHz bands and 4 chains for 2.4 GHz bands. This increase in the number of radio chains helps increase data rates and coverage areas.

As the number of radio chains increase, power usage also increases. For example, a wireless node supporting a high performance state with support for 12 chain operations with all chains in operation may consume 5 watts listening (i.e., in listen mode) for transmissions, and up to 30 watts while transmitting (i.e., in transmit mode).

A wireless node may attempt to save power by entering a lower power mode when there is no wireless activity. However, standards may require transmission of regular beacon frames at set intervals, such as every 100 ms, and the wireless node may need to be available to receive from a transmission from an associated or non-associated STA. These requirements limit the ability of the wireless node to turn off radios, even absent any activity with a STA.

### Access Point Power Save

Wireless access point power savings may be enabled by changing the operating mode and reducing the number of operating radio chains. In a lower power mode, for example, operations in a single band with a single radio chain, power consumption may be reduced to 0.5 watts in listen mode and 3 watts in transmit mode. However, dropping into the lower power mode reduces the capability of the access point as single band operations force client STAs to connect only over a single band, and use of a single radio chain reduces connectively range due to reduced transmission power and antenna diversity.

According to aspects of the present disclosure, power savings may be enabled while minimizing the impact of reduced capabilities resulting from lower power modes by changing the operating mode and reducing the number of operating radio chains based on determined wireless network traffic characteristics. According to certain aspects, an access point may adjust a duty cycle between a higher and a lower power state based on determined wireless network traffic characteristics.

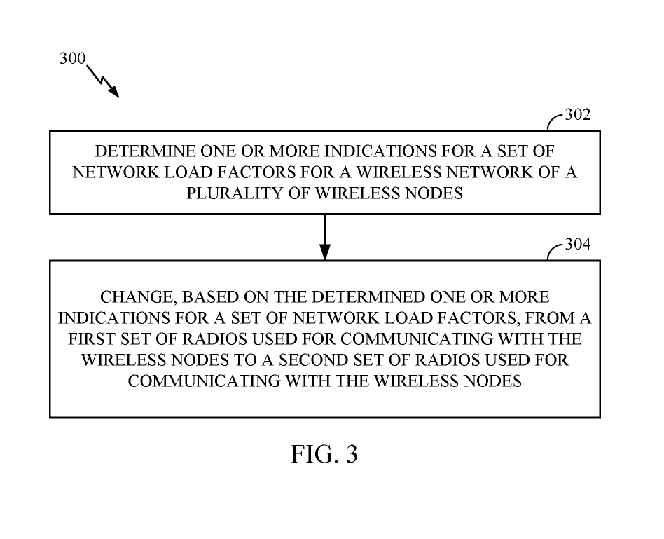

FIG. 3 is a flow diagram illustrating a block diagram of example operations 300 for wireless communications by a base station, in accordance with aspects of the present disclosure. Operations 300 may begin at 302, by determining one or more indications for a set of network load factors for a wireless network of a plurality of wireless nodes. At 304, changing, based on the determined one or more indications for a set of network load factors, from a first set of radios used for communicating with at least one of the wireless nodes to a second set of radios used for communicating with at least one of the wireless nodes.

As will be described below, an access point may switch from a first set of radios to a second set of radios based on a determined wireless network traffic characteristic. As used herein, a low power state generally refers to any state having lower power consumption than another state (e.g., an operating state with only single stream transmissions using a single radio chain, may be considered a low power state relative to a multi-stream antenna state with multiple radio chains, such as a 2×2 or 4×4 operating states) due to reduced processing power (e.g., processing fewer streams for transmission or fewer samples for reception) and by powering down unused radio chains. For example, as discussed above, an AP may support, in a high performance state, 12 radio chains covering two 5 GHz bands and one 2.4 GHz band with four antennas for each band. The AP, in a low power state, may support operations on a single radio chain operating on the 2.4 GHz band. Other low power state variations are possible, for example, supporting two radio chains in different bands or utilizing multiple antennas, and some systems may support multiple low power states.

According to aspects of the present disclosure, an AP may determine one or more characteristics regarding wireless network traffic between the access point and wireless stations. These wireless stations may be stations associated with the AP, as well as stations that are not associated with the AP. In order to reduce the impact of a low power mode on other wireless stations, an AP may attempt to determine one or more indications for a set of network load factors for a wireless network. For example, the AP may attempt to acquire information related to wireless network traffic with the AP in order to decide whether to enter the low power mode. Where an AP determines that there are no wireless stations associated with the AP, the AP may enter a low power state by changing from a high performance mode to a low power mode. In another example, the AP may determine an aggregate traffic load for a wireless network for associated wireless stations, as well as unassociated wireless stations by, for example, measuring activity levels for associated stations and sensing the medium for unassociated stations, and entering a low power state when the aggregate traffic load is below a threshold level. If the aggregate traffic load exceeds the threshold level and the AP is in a low power state, the AP may exit the low power state and change to a high performance state.

Where one or more wireless stations are associated with an AP, the AP may enter a low power state based, at least in part, on characteristics of the network traffic between the AP and associated stations. For example, the AP may determine an indication of a traffic load between the AP and associated stations. Where the indicated traffic load is below a threshold amount or where the AP and associated stations are not actively exchanging data traffic, the AP may enter the low power mode. If the traffic load increases above the threshold amount or if an associated station begins to actively exchange data traffic with the AP, the AP may exit a low power and change to a high performance mode.

Similarly, if the AP, operating in a low power mode, detects certain types of data traffic from the associated station requiring high performance (for example high bandwidth video), the AP may change to the high performance mode. The AP may also change to the high performance mode based on a latency requirement for one or more associated stations. In another example, the AP may determine an indication of a distance between each of the associated stations and the AP and enter a low power mode when the indicated distance to each of the associated stations is below a threshold distance. The AP may continue to monitor the distance to each of the associated stations after entering the low power mode. Where one or more associated stations are moved such that the distance to the one or more associated station is above the threshold distance, for example, near or at the edge of the wireless network, the AP may exit the low power mode and enter a higher power mode.

According to aspects of the present disclosure, an AP may also be configured, for example, based on a policy to permit or prohibit the AP entering a low power state during certain times of the day, certain days of the week, or other specified times. Based on these policies, the AP may change from a high performance mode to a low power mode, or from a low power mode to a high performance mode.

According to aspects of the present disclosure, an access point, as a part of entering or exiting a low power mode may transmit a band steering signal to each associated wireless device indicating a change of bands between a first set of radios and a second set of radios. This second set of radios may be a subset of the first set of radios. For example, an AP supporting three bands in high performance state may support one band in a low power state. As a part of changing to the low power mode, the AP may transmit to each associated wireless device, for example, a disassociation request or an 802.11v transition request, indicating to the associated wireless devices to change bands. Similarly, the AP, as a part of changing to the high performance mode, may transmit to the associate wireless devices, an indication to the wireless devices to change bands. Where the associated wireless device indicates to the AP that the associated wireless device does not support the bands used by the second set of radios, the AP may refrain from entering the low power state.

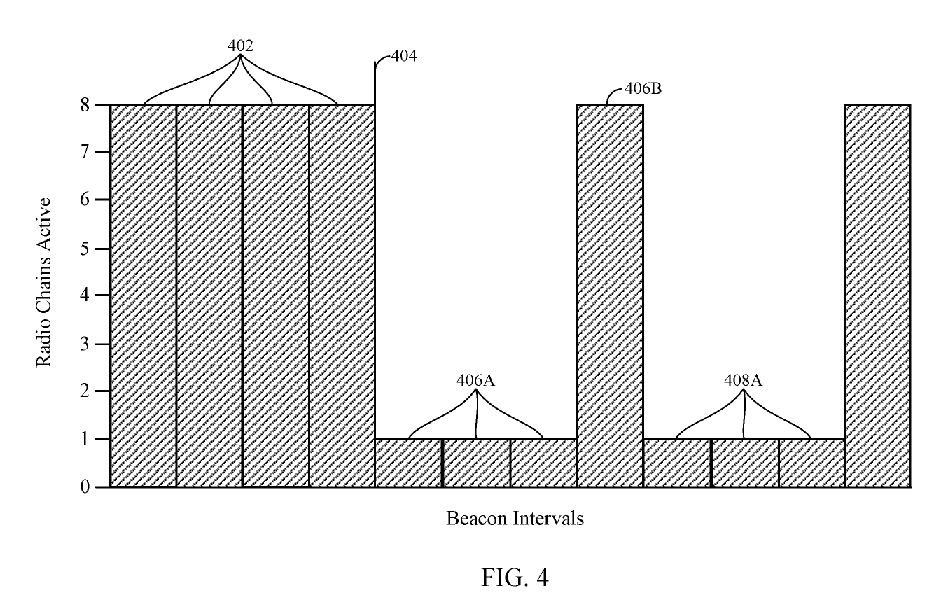

An AP may decide to and enter and exit the low power mode transparently to associated wireless stations. FIG. 4 illustrates a diagram of example duty cycles, in accordance with certain aspects of the present disclosure. According to certain aspects, a low power mode may be characterized by duty cycling between a high performance state and a low power state, based on a time period corresponding to a beacon interval of the AP. As discussed above, standards may require transmission of regular beacon frames at set intervals, such as every 100 ms. The AP, in a high performance mode 402, may utilize all available radio chains and may transmit the beacon during each interval as usual. The AP may decide, at 404, based on wireless network traffic characteristic, to enter a low power mode and change from utilizing a first set of radio chains in the high performance state, to utilizing a second set of radio chains in the low performance state, where the second set comprises fewer radio chains than the first set. Here, the low power state utilizes a single radio chain. The AP may continue to send its beacon broadcasts and respond to requests in the single radio chain configuration.

After entering a low power mode, the AP may duty cycle between the low power state 406A and the high performance state 406B. This duty cycle may be based on the beacon interval, such that the AP operates in a low power state 406A for one or more beacon intervals before changing to a high performance state 406B for one or more beacon intervals and then changing back to a low performance state 408A. As shown, after entering the low power mode, the duty cycle is 75% to 25%, with the AP operating in a low power state for 75% of the duty cycle and high performance state for 25% of the duty cycle.

The duty cycle between the low power state 406A and the high performance state 406B may also be within a beacon interval. In such configurations, the AP may operate in a low power state 406A for one or more power intervals and then change to a high performance state 408A for one or more power intervals, where the power intervals comprise a shorter period of time than the beacon interval. According to certain aspects, a beacon interval may be divided into a number of power intervals. For example, for an AP with a 100 ms beacon interval and a low power mode with a duty cycle of 75% to 25%, the AP may operate in a low power state for a 75 ms portion of the beacon interval and in a high performance state for the remaining 25 ms portion of the beacon interval. Beacon frames may then be consistently transmitted in the high performance state.

The duty cycle may further be adjusted, for example, to support an intermediate low power mode and the AP may change from various power modes based on wireless network traffic characteristics, as discussed above. As such, the duty cycle may be adjusted based on, for example, an indication of traffic load of a wireless network, distance between the associated wireless stations and the AP, the time of day or day of the week. The duty cycle may also be adjusted based on latency requirements for one or more associated wireless stations and increasing the percentage of time spent in the high performance mode when low latency is required.

Duty cycling between the high performance state and low power state allows the AP to avoid degradation at long ranges. For example, if the AP stays for an extended period in the low power state, wireless stations near a coverage edge may experience connection issues that are addressed by the high performance state. Duty cycling allows those more distant wireless stations, along with wireless stations operating in different or multiple bands, to continue to communicate with the AP while still balancing power savings. For example, the AP may be sending DL traffic to a wireless station near the coverage edge at a moderate bitrate due to external factors. This moderate bitrate may be adequately served by the cycles spent in the high performance state while the AP is in the low power mode and thus the AP may enter (or stay) in the low power mode.

FIG. 5 illustrates a diagram of an example design for a multi-radio chain wireless device 500, in accordance with certain aspects of the present disclosure. The wireless device 500 may include N radio chains 520₁ through 520ₙ, which may be coupled to N antennas 510₁ through 510ₙ, respectively, where N may be any integer value. It should be appreciated, however, that respective radio chains 520 may be coupled to any number of antennas 510 and that multiple radio chains 520 may also share a given antenna 510.

In general, a radio chain 520 may be components necessary to transmit/receive a signal, including a radio that radiates or emits energy in an electromagnetic spectrum, receives energy in an electromagnetic spectrum, or generates energy that propagates via conductive means. By way of example, a radio chain 520 may be a unit that transmits a signal to a system or a device or a unit that receives signals from a system or device. Accordingly, it can be appreciated that a radio chain 520 may be utilized to support wireless communication.

According to certain aspects, respective radio chains 520 may support communication with one or more systems. Multiple radio chains 520 may additionally or alternatively be used for a given system, e.g., to transmit or receive on different frequency bands (e.g., cellular and PCS bands).

According to certain aspects, a digital processor 530 may be coupled to radio chains 520₁ through 520ₙ and may perform various functions, such as processing for data being transmitted or received via the radio chains 520. The processing for each radio chain 520 may be dependent on the radio technology supported by that radio and may include encryption, encoding, modulation, etc., for a transmitter; demodulation, decoding, decryption, etc., for a receiver, or the like.

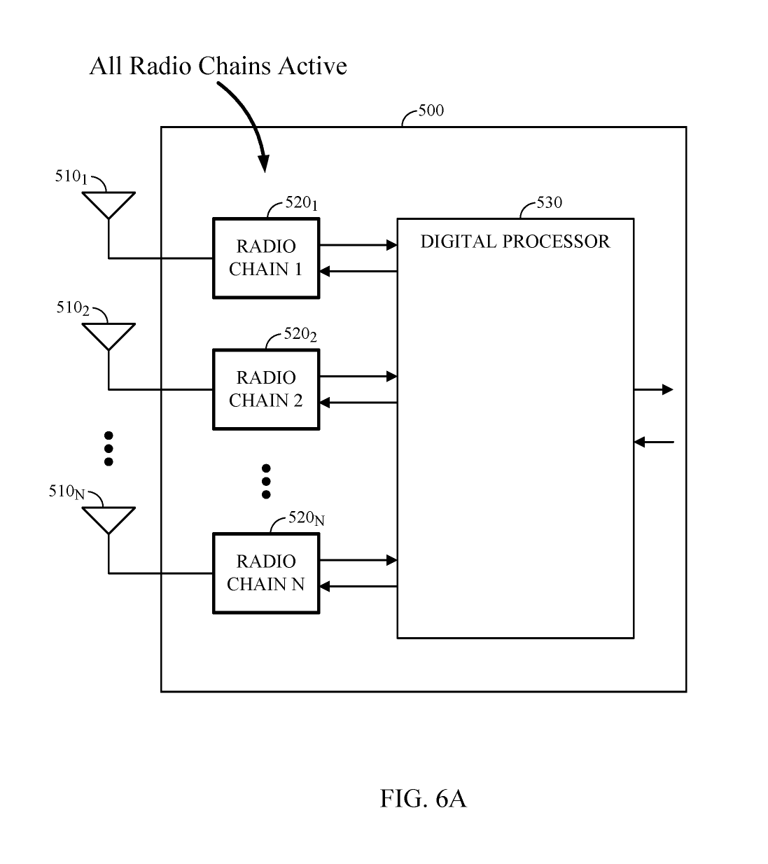

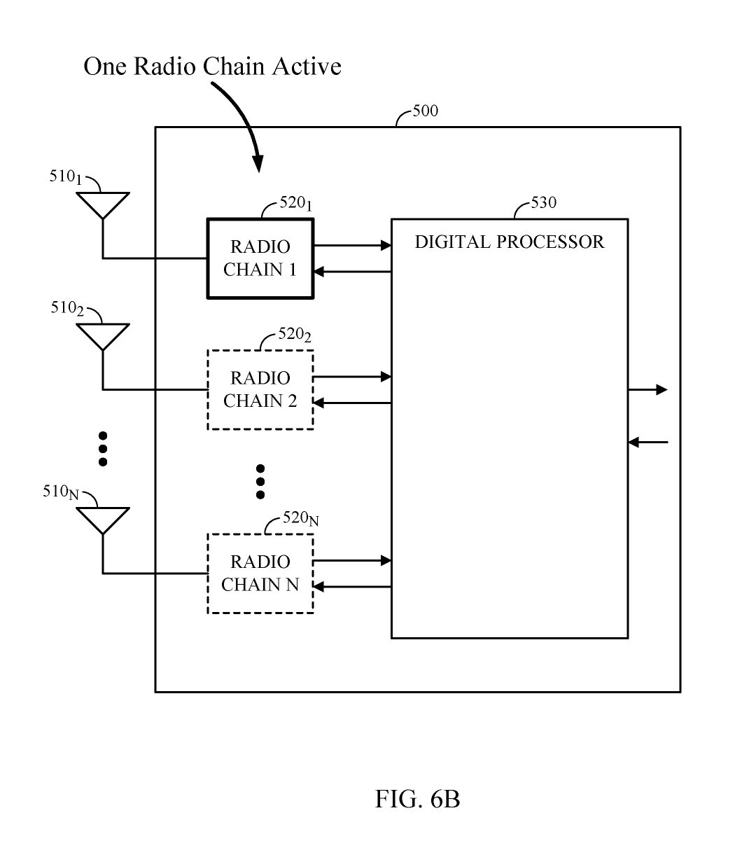

FIG. 6A illustrates a diagram of an example operations of wireless device 500, in accordance with certain aspects of the present disclosure. As shown, the wireless device 500 may operate in a high performance state utilizing all available radio chains (in bold), corresponding with operations shown at 402 and 406B of FIG. 4.

FIG. 6B illustrates a diagram of an example operations of wireless device 500, in accordance with certain aspects of the present disclosure. As shown, the wireless device 500 may operate in a low power state utilizing fewer than all available radio chains (dashed radio chains corresponding to inactive radio chains), corresponding with operations shown at 406A and 408A of FIG. 4

Means for determining, detecting, changing, reducing, enabling, changing, switching, and generating may include a processing system, which may include one or more processors, such as the processors 210, 242, and/or the controller 230 of the access point 110 illustrated in FIG. 2 or the processor 304 and/or the DSP 320 portrayed in FIG. 3. Means for outputting (e.g., transmitting) may comprise a transmitter (e.g., the transmitter unit 222) and/or an antenna(s) 224 of the access point 110 illustrated in FIG. 2.

Means for obtaining (e.g., receiving) may comprise a receiver (e.g., the receiver unit 254) and/or an antenna(s) 252 of the AP 110 illustrated in FIG. 2. Means for determining, means for changing, and means for enabling may include a processing system, which may include one or more processors such as processors 260, 270, 288, and 290 and/or the controller 280 of the AP 110.

Means for communicating may include a means for outputting and/or a means for obtaining as described above. In some cases, rather than actually transmitting (e.g., a packet or frame), a device may have an interface to output a packet or frame for transmission (a means for outputting, a means for sending, and a means for notifying). For example, a processor may output a packet or frame, via a bus interface, to a radio frequency (RF) front end for transmission. Similarly, rather than actually receiving a packet or frame, a device may have an interface to obtain a packet or frame received from another device (a means for obtaining). For example, a processor may obtain (or receive) a packet or frame, via a bus interface, from an RF front end for reception.

According to certain aspects, such means may be implemented by processing systems configured to perform the corresponding functions by implementing various algorithms (e.g., in hardware or by executing software instructions) described above.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. For example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). The term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. The articles “a” and “an” as used in this application and the appended claims should generally be construed to mean “one or more” unless specified otherwise or clear from the context to be directed to a singular form.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, PCM, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer readable storage medium with instructions stored thereon separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be used.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
an interface for communicating with a plurality of wireless nodes via a plurality of antennas;
a memory; and
a processor coupled with the memory and configured to:
determine one or more indications for a set of network load factors for a wireless network of a plurality of wireless nodes; and
change, based on the determined one or more indications for a set of network load factors, from a first set of radios used for communicating with at least one of the wireless nodes to a second set of radios used for communicating with at least one of the wireless nodes.

2. The apparatus of claim 1, wherein the one or more indications for a set of network load factors include at least one of an aggregate traffic load level for the wireless network, a distance between at least one of the plurality of associated wireless nodes and the base station, a number of associated wireless nodes and the base station, a time of day, day of the week, or a set of radio bands supported by the at least one of the plurality of associated wireless nodes.

3. The apparatus of claim 1, wherein the first set of radios comprise one or more of a 2.4 GHz radio, 5 GHz radio, 900 MHz radio, 60 GHz radio, and any other Wi-Fi radio types, and wherein the second set of radios comprise one or more of a 2.4 GHz radio, 5 GHz radio, 900 MHz radio, 60 GHz radio, and any other Wi-Fi radio types.

4. The apparatus of claim 3, wherein the second set of radios is a subset of the first set of radios.

5. The apparatus of claim 1, wherein radios in the first set of radios form one or more first radio chains, and radios in the second set of radios form one or more second radio chains.

6. The apparatus of claim 5, wherein the radios in the second set of radios form less radio chains than the radios in the first set of radios.

7. The apparatus of claim 1, wherein the changing is based on a comparison between the one or more indications for a set of network load factors and a threshold network load factor for the one or more indications.

8. The apparatus of claim 7, wherein the processing system is further configured to:
determine the one or more indications for a set of network load factors is greater than the threshold network load factor for the one or more indications; and
change from the second set of radios to the first set of radios based on the determination.

9. The apparatus of claim 1, wherein the processing system is further configured to:
determine, for each of the plurality of associated wireless nodes, an indication of a distance between each of the plurality of associated wireless nodes and the base station, wherein the set of network load factors includes the indication of the distance of each of the plurality of associated wireless nodes.

10. The apparatus of claim 9, wherein the changing is based on a determination that the distance between each of the plurality of associated wireless nodes and the base station is below a threshold distance.

11. The apparatus of claim 9, wherein the processing system is further configured to:
determine that the distance between each of the plurality of associated wireless nodes and the base station is above a threshold distance; and
change from the second set of radios to the first set of radios based on the determination.

12. The apparatus of claim 1, wherein the changing is further based on at least one of a time of day or a day of the week.

13. The apparatus of claim 1, wherein the processing system is further configured to transmit a band steered signal to each of the plurality of associated wireless nodes indicating a change of bands between the first set of radios and the second set of radios.

14. The apparatus of claim 1, wherein the changing from a first set of radios to the second set of radios according to a duty cycle interval, wherein the duty cycle interval corresponds to a beacon interval of the base station.

15. The apparatus of claim 14, wherein the duty cycle comprises a ratio of a first number of time periods utilizing the first set of radio chains and a second number of time periods utilizing the second set of radio chains.

16. The apparatus of claim 14, wherein the duty cycle is adjusted based on a latency requirement for at least one of the plurality of associated wireless nodes.

17. The apparatus of claim 14, wherein the duty cycle is adjusted based on an indication of a traffic load of the wireless network.

18. The apparatus of claim 14, wherein the duty cycle is adjusted based on an indication of a distance between each of the plurality of associated wireless nodes and the base station.

19. The apparatus of claim 14, wherein the duty cycle is adjusted based on at least one of a time of day or a day of the week.

20. A method for wireless communications by a base station, comprising:
determining one or more indications for a set of network load factors for a wireless network of a plurality of wireless nodes; and
change, based on the determined one or more indications for a set of network load factors, from a first set of radios used for communicating with at least one of the wireless nodes to a second set of radios used for communicating with at least one of the wireless nodes.

21. The method of claim 20, wherein the one or more indications for a set of network load factors include at least one of an aggregate traffic load level for the wireless network, a distance between at least one of the plurality of associated wireless nodes and the base station, a number of associated wireless nodes and the base station, a time of day, day of the week, or a set of radio bands supported by the at least one of the plurality of associated wireless nodes.

22. The method of claim 20, wherein the changing from a first set of radios to the second set of radios according to a duty cycle interval, wherein the duty cycle interval corresponds to a beacon interval of the base station.

23. An apparatus for wireless communications, comprising:
means for determining one or more indications for a set of network load factors for a wireless network of a plurality of wireless nodes; and
means for changing, based on the determined one or more indications for a set of network load factors, from a first set of radios used for communicating with at least one of the wireless nodes to a second set of radios used for communicating with at least one of the wireless nodes.

24. A non-transitory computer-readable medium having instructions stored thereon for:
determining one or more indications for a set of network load factors for a wireless network of a plurality of wireless nodes; and
changing, based on the determined one or more indications for a set of network load factors, from a first set of radios used for communicating with at least one of the wireless nodes to a second set of radios used for communicating with at least one of the wireless nodes.
